(19) United States
(12) Patent Application Publication
(10) Pub. No.: US 2016/0242116 A1
(43) Pub. Date: Aug. 18, 2016

(54) RADIO ACCESS SYSTEM AND BASE STATION APPARATUS

(71) Applicant: FUJITSU LIMITED, Kawasaki-shi (JP)

(72) Inventors: Yoshio Masuda, Kawasaki (JP); NORIO MURAKAMI, Yokohama (JP); Satoshi Watanabe, Yokohama (JP)

(73) Assignee: FUJITSU LIMITED, Kawasaki-shi (JP)

(21) Appl. No.: 15/140,675

(22) Filed: Apr. 28, 2016

Related U.S. Application Data
(63) Continuation of application No. PCT/JP2013/079405, filed on Oct. 30, 2013.

(51) Int. Cl. H04W 52/02; H04W 76/04; H04W 76/06; H04W 16/32

(52) U.S. Cl. CPC H04W 52/0225; H04W 16/32; H04W 76/046; H04W 76/068

(57) ABSTRACT

A radio access system including: a terminal apparatus, and a base station apparatus, wherein a first and second communicable areas of different size are located in hierarchy, the terminal apparatus and the base station apparatus perform radio communication, the base station apparatus includes: a control unit configured to change a time to maintain connection with the base station apparatus in the terminal apparatus and maintain a first state confirming connection to the base station apparatus at predetermined time interval without performing data transmission and reception, to a time longer than a reference time, according to an attribute of the first or second communicable area in which the terminal apparatus locates; and a transmission unit configured to transmit the changed time to the terminal apparatus, and the terminal apparatus includes: a reception unit configured to receive the changed time.

### CROSS-REFERENCE TO RELATED APPLICATION

This application is a continuation application of International Application Number PCT/JP2013/079405 filed on Oct. 30, 2013 and designated the U.S., the entire contents of which are incorporated herein by reference.

### FIELD

The embodiments discussed herein are related to a radio access system and a base station apparatus.

### BACKGROUND

Radio access systems such as a mobile telephone system and a wireless LAN (Local Area Network) are widely in use today. Also, in the field of the radio access system, continuous discussion is being made on a next generation communication technology to further improve the speed and the capacity of communication. For example, in the 3GPP (3rd Generation Partnership Project), which is a standardization association, the standardization of a communication specification called LTE (Long Term Evolution) and LTE-A (LTE-Advanced) based on LTE is completed or under discussion.

Further, the use of a radio access system by a novel terminal represented by a smartphone and a tablet is increasing today. To cope therewith, also in the 3GPP, the standardization of a communication specification in consideration of such a terminal is in progress.

The smartphone performs operation on the premise of continuous (always-on) connection. Therefore, when an application is used in the smartphone, there is continued a state that the smartphone is connected to a radio network such as a base station. For such reason, there is a problem of faster battery consumption in the smartphone than in a feature phone.

To cope with such a problem, a terminal manufacturer introduces, for example, a “Fast Dormancy” function into the smartphone etc. The “Fast Dormancy” function is a function to “disconnect” the connection to the radio network to shift to an “IDLE” state after the completion of data communication, based on the decision on the smartphone side, for example. In the “IDLE” state, the smartphone is disconnected from the radio network, for example. Therefore, the “Fast Dormancy” function enables the suppression of power consumption in the smartphone to elongate a battery available time.

On the other hand, there is a case that the smartphone periodically performs connection confirmation (Keep Alive) to the radio network even after the shift to the “IDLE” state. The connection confirmation is, for example, processing for confirming that the connection between the smartphone and the radio network is valid even in a non-communication state.

In this case, the smartphone performs the connection confirmation after reconnected to the “disconnected” radio network. Since the connection confirmation is performed periodically, the smartphone repeats reconnection and disconnection to/from the radio network for a multiplicity of times. Therefore, there is a case that, because of the connection confirmation, signal traffic (or signaling traffic) between the smartphone and the base station increases even in the smartphone in which the “Fast Dormancy” function is introduced.

As such, although the “Fast Dormancy” function is introduced, for example, to suppress battery consumption in the smartphone, from a differentiate viewpoint, signal traffic is not remarkably reduced, causing a factor to burden a heavy load on the radio network side. Further, the rapid spread of the smartphone produces a larger increase of signal traffic, causing a factor to burden a heavier load on the radio network.

To cope therewith, the 3GPP specifies a “Network Controlled Fast Dormancy” function (which may hereafter be referred to as a “Fast Dormancy (NW)” function).

In the “Fast Dormancy (NW)” function, a radio network, on receiving a request for the “Fast Dormancy (NW)” function from a smartphone, makes the smartphone shifted to an “URA_PCH” state, instead of the “IDLE” state, for example.

In the “URA_PCH” state, although connection to the radio network is contained, the terminal becomes a standby state in which the occurrence of new data or a call from the base station is awaited, for example, without data transmission or reception. Further, in the “URA_PCH” state, for example, the terminal maintains the standby state even if moving within a URA (UTRAN Registration Area) (or a plurality of cell groups), whereas when moving to another URA, the terminal shifts to an active state to transmit/receive a signal.

Accordingly, in the smartphone, when the connection confirmation is performed from the “IDLE” state, connection processing to the radio network is performed, whereas when connection confirmation is performed from the “URA_PCH” state, no connection processing to the radio network is performed because the smartphone is in the state of already connected to the radio network.

Thus, by the “Fast Dormancy (NW)” function, it is possible to reduce signal traffic as compared to a case in which reconnection is made from the “IDLE” state, to thereby suppress power consumption in the smartphone and elongate the battery available time.

Furthermore, there has been adopted new network architecture called HetNet (Heterogeneous Network) in order to cope with an increased communication volume in the overall network accompanying a remarkable spread of the smartphone.

The HetNet can improve the overall capacity of a radio access system by the use of a hierarchical configuration composed of a variety of sizes of cells, such as a microcell, a pico cell, etc.

### CITATION LIST

### Non-Patent Document

Non-patent document 1: 3GPP TS25.331 V9.15.0 (2013-06)

Although the “Fast Dormancy (NW)” function is specified in the 3GPP, there has been no specification on a method for further signal traffic suppression to enable the long-time use of a battery in a terminal such as a smartphone.

Also, no solution has been given on a generic method for signal traffic suppression, even taking network architecture such as the HetNet into consideration.

### SUMMARY

According to one aspect of the embodiments, a radio access system including: a terminal apparatus, and a base station apparatus, wherein a first and second communicable areas of different size are located in hierarchy, the terminal apparatus moving from the first communicable area to the second communicable area and the base station apparatus perform radio communication, the base station apparatus includes: a control unit configured to change a time to maintain connection with the base station apparatus in the terminal apparatus and maintain a first state confirming connection to the base station apparatus at predetermined time interval without performing data transmission and reception, to a time longer than a reference time, according to an attribute of the first or second communicable area in which the terminal apparatus locates; and a transmission unit configured to transmit the changed time to maintain the first state to the terminal apparatus, and the terminal apparatus includes: a reception unit configured to receive the changed time to maintain the first state.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a radio access system.

FIG. 2 is a diagram illustrating a configuration example of a radio access system.

FIG. 3 is a diagram illustrating a configuration example of a radio base station apparatus.

FIG. 4 is a diagram illustrating a configuration example of a terminal apparatus.

FIG. 5 is a diagram illustrating a configuration example of a HetNet in a radio access system.

FIG. 6A is a diagram illustrating an example of state transition when terminal controlled FD is applied, and FIG. 6B is a diagram illustrating an example of state transition when network controlled FD is applied, respectively.

FIGS. 7A through 7C are diagrams illustrating examples of state transition operation when FD is applied.

FIG. 8 is a sequence chart illustrating an operation example of a radio access system.

FIG. 9 is a flowchart illustrating an operation example of a base station apparatus.

FIGS. 10A and 10B are flowcharts illustrating operation examples of a base station apparatus.

FIGS. 11A and 11B are flowcharts illustrating operation examples of a base station apparatus.

FIG. 12 is a flowchart illustrating an operation example of a base station apparatus.

FIGS. 13A and 13B are diagrams illustrating examples of bearer hold timer set values.

FIG. 14 is a diagram illustrating a configuration example of a radio access system.

FIG. 15A is a diagram illustrating a HetNet configuration example; FIGS. 15B and 15C are diagrams illustrating examples of information update timing when a terminal in each state moves; FIG. 15D is a diagram illustrating an example of information update timing when a terminal is in a URA_PCH state and stationary; and FIGS. 15E and 15F are diagrams illustrating examples of information update timing when a terminal in each state moves.

FIG. 16 is a diagram illustrating a configuration example of a radio base apparatus.

FIG. 17 is a diagram illustrating a configuration example of a radio base apparatus.

### DESCRIPTION OF EMBODIMENTS

Hereinafter the present embodiments will be described in detail by reference to the drawings.

### First Embodiment

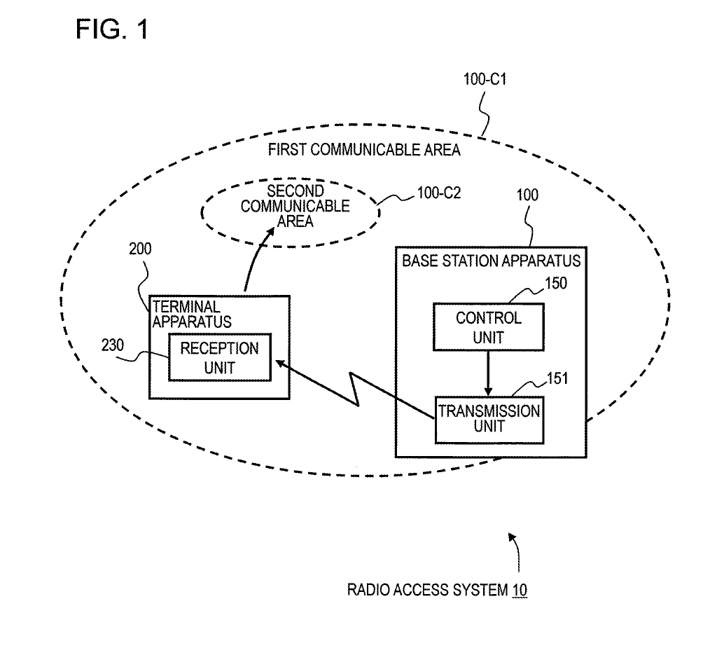

FIG. 1 is a diagram illustrating a configuration example of a radio access system 10. The radio access system 10 includes a base station apparatus 100 and a terminal apparatus 200.

Further, in the radio access system 10, a first communicable area 100-C1 and a second communicable area 100-C2 are located in hierarchy. In the example of FIG. 1, the second communicable area 100-C2 is disposed in the first communicable area 100-C1. However, inversely, the first communicable area 100-C1 may be disposed in the second communicable area 100-C2. The terminal apparatus 200 moves from the first communicable area 100-C1 to the second communicable area 100-C2.

The base station apparatus 100 includes a control unit 150 and a transmitter unit 151.

The control unit 150 changes a time to maintain a first state, in which the terminal apparatus 200 maintains connection with the base station apparatus 100 and confirms the connection to the base station apparatus 100 without data transmission and reception at predetermined time intervals, to a longer time than a reference time according to the attribute of the first or second communicable area 100-C1, 100-C2 in which the terminal apparatus 200 is located.

The transmitter unit 151 transmits the changed time to maintain the first state to the terminal apparatus 200.

The terminal apparatus 200 includes a receiver unit 230. The receiver unit 230 receives the changed time to maintain the first state.

As such, in the present first embodiment, the time to maintain the first state is changed to a time longer than the reference time, according to the attribute of the first or second communicable area 100-C1, 100-C2. This enables the terminal apparatus 200 in the first state to confirm connection with the base station apparatus 100, for example.

In this case, the terminal apparatus 200 is not transmit or receive a control signal for reconnection, as compared to, for example, a case of performing connection confirmation after becoming a second state in which the connection with the base station apparatus 100 is disconnected. This enables the suppression of signal traffic accordingly.

Further, by the suppressed signal traffic, for example, the number of transmitted and received control signals is suppressed in the terminal apparatus 200. The non-execution of control signal transmission and reception can cause the suppression of power consumption and the elongation of the battery available time than a threshold.

### Second Embodiment

Next, a second embodiment will be described. The second embodiment will be described in the following order.

<1. Configuration example of radio access system>

<2. Configuration examples of base station and terminal>

<3. Configuration example of HetNet>

<4. Examples of state transition>

<5. Operation examples>

### 1. Configuration Example of Radio Access System

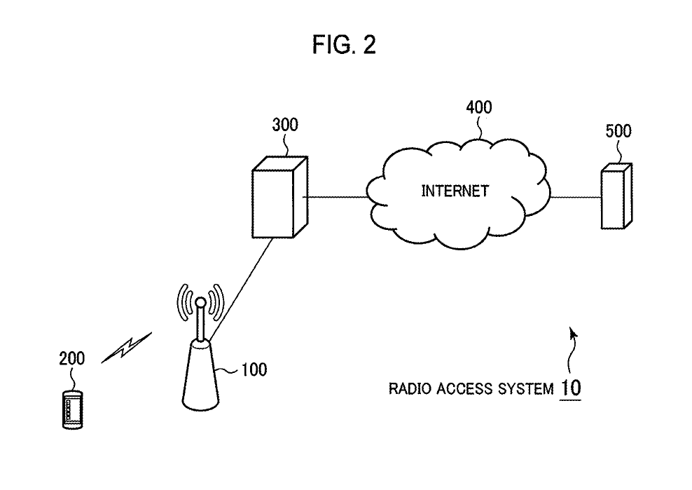

FIG. 2 is a diagram illustrating a configuration example of a radio access system 10. The radio access system 10 includes a base station apparatus (which may hereafter be referred to as “base station”) 100, a terminal apparatus (which may hereafter be referred to as “terminal”) 200, a CN (Core Network) 300 and a content server 500. Also, in the radio access system 10, the CN 300 and the content server 500 are connected through the Internet 400.

In the present radio access system 10, the terminal 200 is, for example, a smartphone, a tablet, etc., and includes the “Fast Dormancy” function. The “Fast Dormancy” function according to the second embodiment is performed under control from the radio network (NW) side, such as the base station 100 and the CN 300. The detail of the NW controlled “Fast Dormancy” function by will be described later.

The base station 100 is a radio communication apparatus which performing radio communication with the terminal 200. Also, the base station 100 can perform bidirectional radio communication with the terminal 200 in a communicable area (which may be referred to as a “cell area” or a “cell”).

More specifically, there are data transmission (or downlink communication) from the base station 100 to the terminal 200 and data transmission (or uplink communication) from the terminal 200 to the base station 100. The base station 100 performs scheduling etc. to allocate each radio resource (for example, a time resource and a frequency resource) to the terminal 200. The base station 100 transmits the allocated radio resource to the terminal 200 as a control signal. The base station 100 and the terminal 200 perform downlink communication and uplink communication using the radio resource.

The terminal 200 is, for example, a movable radio communication apparatus. Through radio communication with the base station 100, the terminal 200 can receive a variety of services including speech communication and home page reading. In the example of FIG. 2, the terminal 200 can receive a content distribution service from the content server 500.

The CN 300 is connected to the content server 500 through the base station 100 and the Internet 400. The CN 300 is switching equipment which manages subscriber information and controls related to call connection, for example. Typically, the CN 300 performs the management of a user contract state, charging control, position registration, moving control including handover etc., bearer establishment and deletion, and so on.

The content server 500 includes, for example, a large capacity storage medium and stores a variety of contents including video and music, so as to distribute a content in response to a request from the terminal 200.

### 2. Configuration Examples of Base Station and Terminal

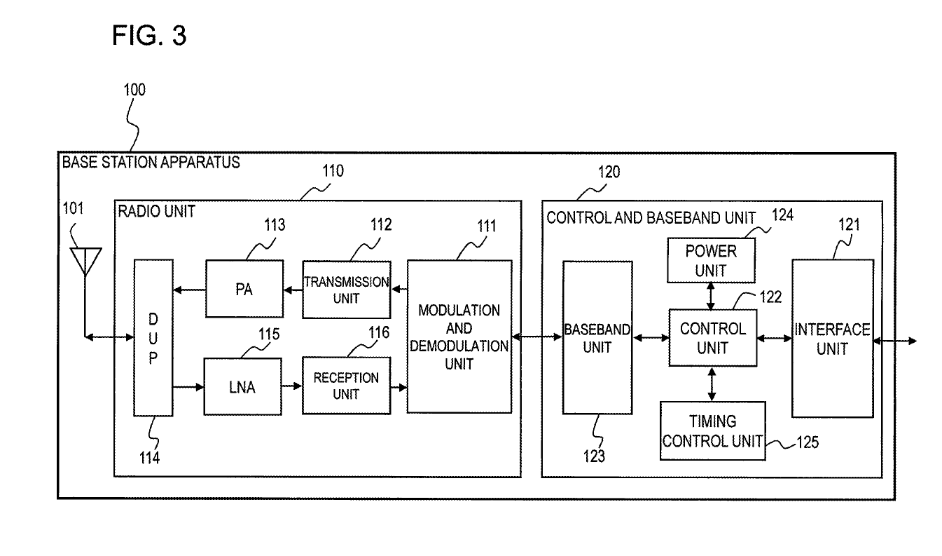

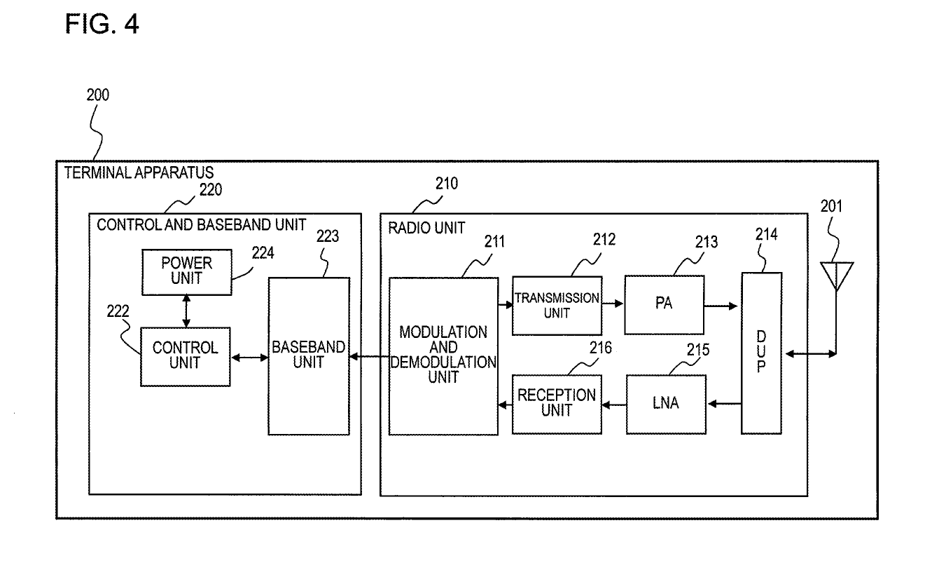

Next, the configuration examples of the base station 100 and the terminal 200. FIG. 3 illustrates a configuration example of the base station 100 and FIG. 4 illustrates a configuration example of the terminal 200, respectively.

The base station 100 includes an antenna 101, a radio unit 110, and a control and baseband unit 120. Further, the radio unit 110 includes a modulation and demodulation unit 111, a transmitter unit 112, a PA (Power Amplifier) 113, a DUP (Duplexer) 114, an LNA (Low Noise Amplifier) 115 and a receiver unit 116. Further, the control and baseband unit 120 includes an interface unit 121, a control unit 122, a baseband unit 123, a power unit 124 and a timing control unit 125.

Here, the control unit 150 in the first embodiment corresponds to, for example, the control unit 122 and the timing control unit 125. Also, the transmitter unit 151 in the first embodiment corresponds to, for example, the baseband unit 123, the radio unit 110 and the antenna 101.

The modulation and demodulation unit 111 performs IFFT (Inverse Fast Fourier Transform) processing etc. on a signal which is output from the baseband unit 123, to convert the signal in the frequency domain into a signal in the time domain. Also, the modulation and demodulation unit 111 performs FFT (Fast Fourier Transform) processing etc. on a signal which is output from the receiver unit 116, to convert the signal in the time domain into a signal in the frequency domain. In order to enable such processing, the modulation and demodulation unit 111 may be configured to internally include an IFFT circuit, an FFT circuit, etc.

The transmitter unit 112 converts (upconverts) the time domain signal which is output from the modulation and demodulation unit 111 into a radio signal in a radio band, to output the radio signal to the PA 113. For this purpose, the transmitter unit 112 may be configured to internally include a frequency conversion circuit.

The PA 113 amplifies the radio signal output from the transmitter unit 112.

The PA 113 may be configured to internally include an amplifier circuit.

The DUP 114 outputs the radio signal output from the PA 113 to the antenna 101, and also outputs a radio signal output from the antenna 101 to the LNA 115. The DUP 114 is, for example, an antenna duplexer or an antenna splitter.

The antenna 101 transmits the radio signal output from the DUP 114 to the terminal 200. Also, the antenna 101 receives a radio signal transmitted from the terminal 200 to output to the DUP 114.

The LNA 115 amplifies the radio signal output from the DUP 114. The LNA 115 is, for example, a high frequency amplifier or a low noise amplifier, and may internally include an amplifier circuit.

The receiver unit 116 converts (downconverts) a radio band signal output from the LNA 115 into a baseband signal, to output the converted signal to the modulation and demodulation unit 111. The receiver unit 116 may also be configured to internally include a frequency conversion circuit.

The interface unit 121 converts data, a control signal, etc. which are output from the control unit 122 into a format capable of transmission to the CN 300, such as, for example, packet data, to transmit the converted packet data to the CN 300. Also, the interface unit 121 receives packet data from the CN 300, and extracts data, a control signal, etc. from the packet data to output to the control unit 122.

The control unit 122 outputs data, a control signal, etc. output from the baseband unit 123, to the interface unit 121 to instruct the interface unit 121 to transmit to the CN 300. By this, the data, the control signal, etc. are transmitted to the CN 300.

Also, the control unit 122 outputs the data and the control signal output from the interface unit 121 to the baseband unit 123, to control to transmit to the terminal 200. For example, the control unit 122 determines radio resource allocation (for example, frequency and time) to the terminal 200, a modulation system, etc. to schedule. The control unit 122 generates a control signal including scheduling information, to transmit to the terminal 200 through the baseband unit 123.

Further, the control unit 122 instructs the power unit 124 to switch on or off the power of the base station 100 to thereby control the power of the base station 100.

In the present second embodiment, the control unit 122 and the timing control unit 125 perform processing related to the change of bearer hold timer setting. The detail thereof will be described later.

The baseband unit 123 performs error correction coding processing, modulation processing such as QPSK (Quadrature Phase Shift Keying) on the data, the control signal, etc. output from the control unit 122, to output a signal after the modulation processing to the modulation and demodulation unit 111. Also, the baseband unit 123 performs demodulation processing, error correction decoding processing, etc. on a signal output from the modulation and demodulation unit 111, to extract data, a control signal, etc. to output to the control unit 122.

The power unit 124 switches on and off the power of the overall base station 100 or the radio unit 110 in the base station 100, according to the instruction from the control unit 122.

As depicted in FIG. 4, the terminal 200 includes an antenna 201, a radio unit 210 and a control and baseband unit 220. Further, the radio unit 210 includes a modulation and demodulation unit 211, a transmitter unit 212, a PA 213, a DUP 214, an LNA 215 and a receiver unit 216. Further, the control and baseband unit 220 includes a control unit 222, a baseband unit 223 and a power unit 224.

Here, the receiver unit 230 in the first embodiment corresponds to, for example, the antenna 201, the radio unit 210 and the baseband unit 223.

The antenna 201 receives a radio signal transmitted from the base station 100, and outputs the received radio signal to the DUP 214. Also, the antenna 201 transmits a radio signal output from the DUP 214 to the base station 100.

The modulation and demodulation unit 211 performs IFFT processing etc. on a signal output from the baseband unit 223, to convert into a time domain signal. Also, the modulation and demodulation unit 211 performs FFT processing etc. on a signal output from the receiver unit 216, to convert into a frequency domain signal.

The transmitter unit 212 converts (upconverts) the time domain signal output from the modulation and demodulation unit 211 into a radio band signal.

The PA 213 amplifies the radio signal output from the transmitter unit 212.

The DUP 214 outputs the radio signal, output from the PA 213, to the antenna 201, and outputs a radio signal, output from the antenna 201, to the LNA 215.

The LNA 215 amplifies the radio signal output from the DUP 214 to output to the receiver unit 216.

The receiver unit 216 converts the radio signal into a baseband signal, to output to the modulation and demodulation unit 211.

The baseband unit 223 performs demodulation processing, error correction decoding processing, etc. on a signal output from the modulation and demodulation unit 111 to extract data, a control signal, etc. Also, the baseband unit 223 performs error correction coding processing, modulation processing on data, a control signal, etc. which are output from the control unit 222, to output the signal after modulation processing to the modulation and demodulation unit 211.

The control unit 222 receives the control signal and the data from the baseband unit 223, to output the data etc. to a monitor, a speaker, etc. to perform the output control of video and voice. Also, the control unit 222, on receiving video and voice data from the monitor and a microphone, outputs the received data to the baseband unit 223 so as to be transmitted to the base station 100.

In the present second embodiment, the control unit 222, on detecting that the terminal 200 is in a non-communication state for a certain period, generates a disconnection request signal including SCRI (or a disconnection request message, which may hereafter be referred to as an “SCRI message”) to transmit to the base station 100. The detail will be described later.

The power unit 224 switches on or off the power of the terminal 200, according to an instruction from the control unit 222.

### 3. Configuration Example of HetNet

In the present second embodiment, the radio access system 10 configures a HetNet environment. The HetNet signifies a hierarchical network constituted by various sizes of cells. The example of the radio access system 10 depicted in FIG. 2 illustrates an example of one base station 100 for easy explanation. However, the HetNet environment may be constituted by a plurality of base stations, for example.

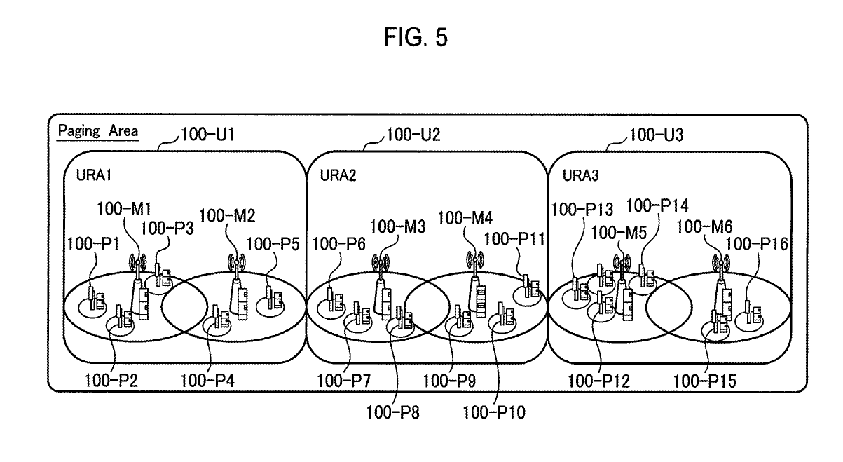

FIG. 5 is a diagram illustrating an example of a HetNet environment in the radio access system 10. In the example of FIG. 5, there are included 6 macro cells 100-M1 to 100-M6 in the radio access system 10.

Also, pico cells 100-P1 to 100-P6 are included in each macro cell 100-M1 to 100-M6. For example, three pico cells 100-P1 to 100-P3 are included in the macro cell 100-M1, and two pico cells 100-P4 to 100-P5 are included in the macro cell 100-M2.

In the following, a cell having a smaller cell area than the macro cell 100-M1 to 100-M6 may be referred to as a “small cell”, for example. In the small cell, there are included a pico cell, a micro cell, a femto cell, etc.

“Cell” is a service provision area by the base station 100, for example, and also a radio communicable area of the base station 100. The base station 100 may include one cell or a plurality of cells, for example. The base station 100 and each cell thereof may integrally be referred to as “cell”, for example.

In the example of the HetNet environment depicted in FIG. 5, there is illustrated an example such that macro cells 100-M1 to 100-M6 include a plurality of small cells 100-P1 to 100-P16. However, each macro cell 100-M1 to 100-M6 may include one small cell.

In the example of the HetNet environment depicted in FIG. 5, a plurality of cells are grouped into URA (UTRAN Registration Area) 1 (100-U1) to URA3 (100-U3). The URA1 (100-U1) includes the macro cells 100-M1 and 100-M2, the URA2 (100-U2) includes the macro cells 100-M3 and 100-M4, and the URA3 (100-U3) includes the macro cells 100-M5 and 100-M6, respectively.

The URA is constituted by a plurality of grouped cells. If a terminal 200 which is in the “URA_PCH” state moves from one cell to another within the same URA, the terminal 200 does not notify the base station 100 of new cell information. On the other hand, if the terminal 200 in the “URA_PCH” state moves to another cell in a different URA, the terminal 200 notifies the base station 100 of new cell information. In other words, the terminal 200 in the “URA_PCH” state does not perform cell information notification processing etc. if moving to the other cell within the same URA. This enables the prevention of a signal traffic increase in comparison with a case of performing such cell information notification processing. The details of the “URA_PCH” state will be described later.

Incidentally, notification processing of the new cell information by the terminal 200 may also be referred to as, for example, Cell_update. For example, when the terminal 200 detects, in comparison with a reception signal level from the connected base station, a larger reception signal level from another base station, the terminal 200 performs the Cell_update by notifying the connected base station about the reception signal level of the other base station.

In the example of the HetNet environment depicted in FIG. 5, there is further provided a paging area. The paging area signifies an area in which the CN 300, on receiving an incoming call from another CN etc., distributes the incoming call, for example. In the example of FIG. 5, the URA1 (100-U1) to the URA3 (100-U3) constitute one paging area.

In this case, the terminal 200 in the “IDLE” state does not perform position registration processing (for example, Location Registration) or the like while the terminal 200 is located in the same paging area, whereas performs position registration processing (for example, Location Registration) when moving to another paging area. The description of the “IDLE” state will also be given later.

### 4. Examples of State Transition

The terminal 200 can receive data or become a sleep state while shifting the state thereof. Now, the state transition of the terminal 200 will be described below.

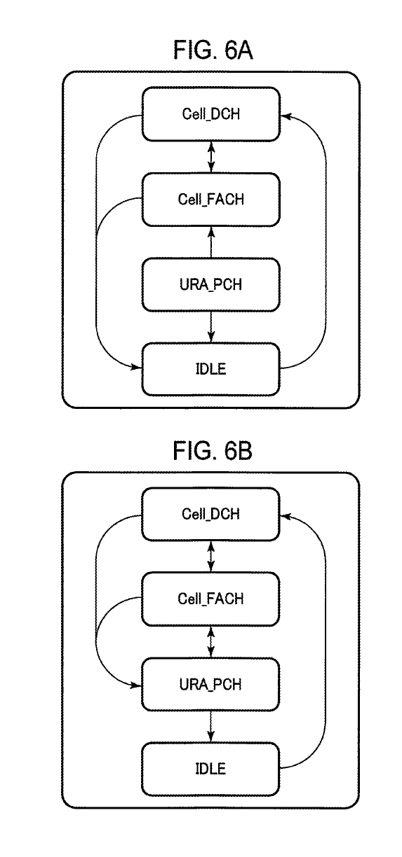

FIGS. 6A and 6B illustrate examples of state transition in the terminal 200. The terminal 200 shifts among four states: “Cell_DCH”, “Cell_FACH”, “URA_PCH” and “IDLE”. FIG. 6A illustrates a state transition example when the terminal controlled “Fast Dormancy” function (which may hereafter be referred to as “FD (terminal)”) is performed, whereas FIG. 6B illustrates a state transition example when the network controlled “Fast Dormancy” function (which may hereafter be referred to as “FD (NW)”) is performed.

The “FD (terminal)” is, for example, a function in which after the completion of data communication, the terminal 200 “disconnects” connection with the radio network on the basis of the decision of the terminal 200, to shift to the “IDLE” state. Therefore, as depicted in FIG. 6A, the terminal 200 can shift from the “Cell_DCH” or the “Cell_FACH” to the “IDLE”.

On the other hand, the “FD (NW)” is, for example, a function in which the base station 100 or the CN 300 (which may hereafter be referred to as a “radio network”), on receiving from the terminal 200 an execution request of the “Fast Dormancy” function, shifts the state of the terminal 200 to the “URA_PCH” state, not to the “IDLE” state. Accordingly, as depicted in FIG. 6B, the terminal 200 can shift from the “Cell_DCH” or the “Cell_FACH” to the “URA_PCH”, not to the “IDLE”.

When shifting to the “IDLE”, the terminal 200 is disconnected from the radio network. Therefore, in order that the terminal 200 shifts to the “Cell_DCH” to reconnect to the radio network, the terminal 200 transmits a connection request message, such as RRC Connection Reconfiguration, for example.

On the other hand, if shifting to the “URA_PCH”, the terminal 200 does not transmit a connection request message like RRC Connection Reconfiguration because connection with the radio network is continued.

Therefore, a signal traffic amount, which is to be transmitted and received when the terminal 200 shifts from the “URA_PCH” to the “Cell_DCH”, becomes smaller than a signal traffic amount to be transmitted and received when the terminal 200 shifts from the “IDLE” to the “Cell_DCH”.

Accordingly, as compared to the “FD (terminal)”, the “FD (NW)” can reduce a load on the radio network. More specific examples related to the number of control signals etc. will be described later.

Now, each state of the terminal 200 will be described below.

The “Cell_DCH” is a state in which, for example, the terminal 200 and the base station 100 are connected through an individual channel (DCH: Dedicated Channel).

In the “Cell_DCH” state, because data transmission/reception is performed, power consumption in the terminal 200 becomes larger as compared to other states.

The “Cell_FACH” is a state in which, for example, the terminal 200 and the base station 100 are connected through a common channel (FACH: Forward Access Channel). In the “Cell_FACH”, because data transmission/reception is performed in the case of necessity, power consumption is smaller than in the “Cell_DCH”. Further, in the case of the “Cell_FACH” state, a data amount capable of transmission/reception becomes smaller than in the “Cell_DCH”, because a plurality of terminals transmit data using each limited shared channel.

The “URA_PCH” is, for example, a state (or a sleep state) in which the terminal 200, which is connected to the base station 100 etc., waits for the occurrence of new data or a call from the base station 100 without data transmission and reception. Further, in the URA, the terminal 200 in the “URA_PCH” state moves in the sleep state, and therefore, the power consumption is smaller than in the “Cell_DCH”. Further, the terminal 200 in the “URA_PCH” state does not perform Cell_update if the terminal 200 moves from one cell to another cell in the same URA, whereas performs Cell_update if moving to another cell in a different URA.

The “IDLE” is, for example, a state in which the terminal 200, whose connection with the radio network is disconnected, waits for the occurrence of new data or a call from the base station 100, without data transmission and reception. The terminal 200 in the “IDLE” state does not perform Cell_update if moving from one cell to another in the same paging area, whereas performs notification of new paging area information (for example, Location Registration) when moving to another paging area.

The “Cell_DCH” and the “Cell_FACH” states may be referred to as an active state, for example.

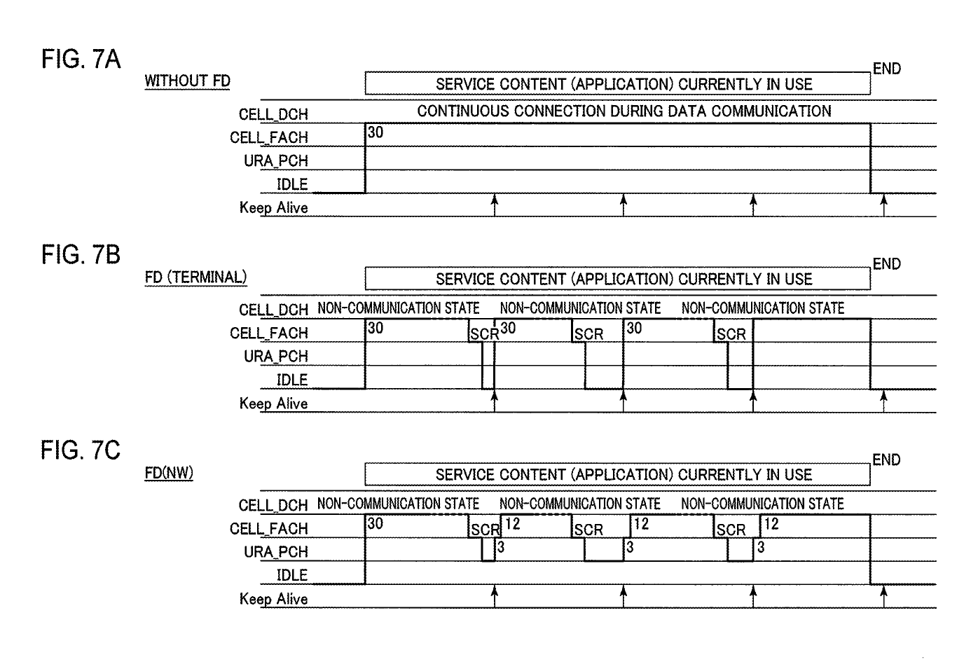

FIGS. 7A through 7C illustrate operation examples of shift transition in the terminal 200. In FIGS. 7A through 7C, the horizontal axis represents time, whereas the vertical axis represents state transition.

FIG. 7A illustrates an example of state transition in the terminal 200 without provision of the “Fast Dormancy” function (which may hereafter be referred to as “without FD”).

In the case of “without FD”, the terminal 200 is continuously in the “Cell_DCH” when an application is in use. The terminal 200 maintains the “Cell_DCH” even when no communication state exists.

Here, the terminal 200 performs Keep Alive (or connection confirmation) to the base station 100 and the CN 300 after the lapse of each predetermined period (or at predetermined time intervals). Such Keep Alive enables the terminal 200 to confirm a valid connection with the radio network side.

In the case of “without FD”, because the terminal 200 maintains the “Cell_DCH” during the use of application, the terminal 200 can perform the Keep Alive without particular state transition.

FIG. 7B is an operation example of state transition in the terminal 200 in a case based on the “FD (terminal)”.

In the case of the “FD (terminal)” also, when the use of application is started, transition is made from the “IDLE” to the “Cell_DCH”. the When non-communication state continues after shifting to the “Cell_DCH”, the terminal 200 shifts to the “Cell_FACH”, and transmits an SCRI message to the base station 100. Thereafter, the terminal 200 shifts to the “IDLE” by its own decision.

In the case of the “FD (terminal)” also, the terminal 200 performs the Keep Alive after the lapse of each predetermined time. FIG. 7B illustrates an example in which the terminal 200, after shifting to the “IDLE”, performs the Keep Alive from the “IDLE” state because the predetermined time elapses.

In this case, in order to perform processing related to the Keep Alive, the terminal 200 shifts from the “IDLE” to the “Cell_DCH”. The terminal 200 then transmits and receives each control signal related to the Keep Alive, so as to perform the Keep Alive.

To perform the Keep Alive, the terminal 200 shifts from the “IDLE” to the “Cell_DCH”, and the number of control signals to be transmitted and received at the shift is “30”, as an example.

FIG. 7C illustrates an operation example of state transition in the terminal 200 in a case based on the “FD (NW)”.

In the case of the “FD (NW)”, if non-communication state continues in the “Cell_DCH”, the terminal 200 shifts to the “Cell_FACH”, and transmits an SCRI message. Thereafter, the terminal 200, on receiving notification from the base station 100, shifts to the “URA_PCH”, for example.

In the case of the “FD (NW)” also, the terminal 200 performs the Keep Alive whenever a predetermined time elapses. In FIG. 7C, there is illustrated an example in which, after shifting to the “URA_PCH”, the terminal 200 performs the Keep Alive from the “URA_PCH” state because the predetermined time elapses.

In this case, to perform processing related to the Keep Alive, the terminal 200 shifts from the “URA_PCH” to the “Cell_DCH” through the “Cell_FACH”. Then, the terminal 200 in the “Cell_FACH” transmits and receives each control signal related to the Keep Alive, so as to perform the Keep Alive. The number of control signals transmitted and received when shifting from the “URA_PCH” to the “Cell_DCH” is “15”, as an example.

As such, the number of control signals transmitted and received at the shift from the “URA_PCH” to the “Cell_DCH” is smaller than the number of control signals transmitted and received at the shift from the “IDLE” to the “Cell_DCH”. The reason is that, because the terminal 200 in the “URA_PCH” state is connected to the radio network, no transmission and reception of a connection request message etc., for example, is performed, as described earlier.

In the “FD (terminal)” and the “FD (NW)”, in each state among the existent four states, a time to maintain the state is fixed in advance, as a reference time (or a reference value), for example. Such a reference time may be held in the memory of the terminal 200, for example.

For example, in the case of the “FD (NW)”, a set time in which the terminal 200 maintains the “URA_PCH” state is also fixed as a reference value.

The reason for such fixation of time to maintain the “URA_PCH” state etc. as the reference time is as follows, for example.

Namely, in each state like the “Cell_DCH”, each radio resource for the individual channel and the shared channel is secured. However, when considering other data communication, it is not appropriate to secure the secured radio resource continuously and permanently. It is rather appropriate to release the secured radio resource after the lapse of a certain time. Therefore, in each state like the “URA_PCH” etc. for example, a set time to maintain the state is fixed as the reference value.

In the present second embodiment, the set time to maintain the “URA_PCH” in the “FD (NW)” is fixed as a reference time, for example. However, the set time can be set longer than the reference time according to the attribute of the cell. This enables further suppressing a signal traffic amount when the “FD (NW)” is performed, for example. Hereafter, the detail thereof will be described in an operation example.

### 5. Operation Example

An operation example in the present second embodiment will be described below.

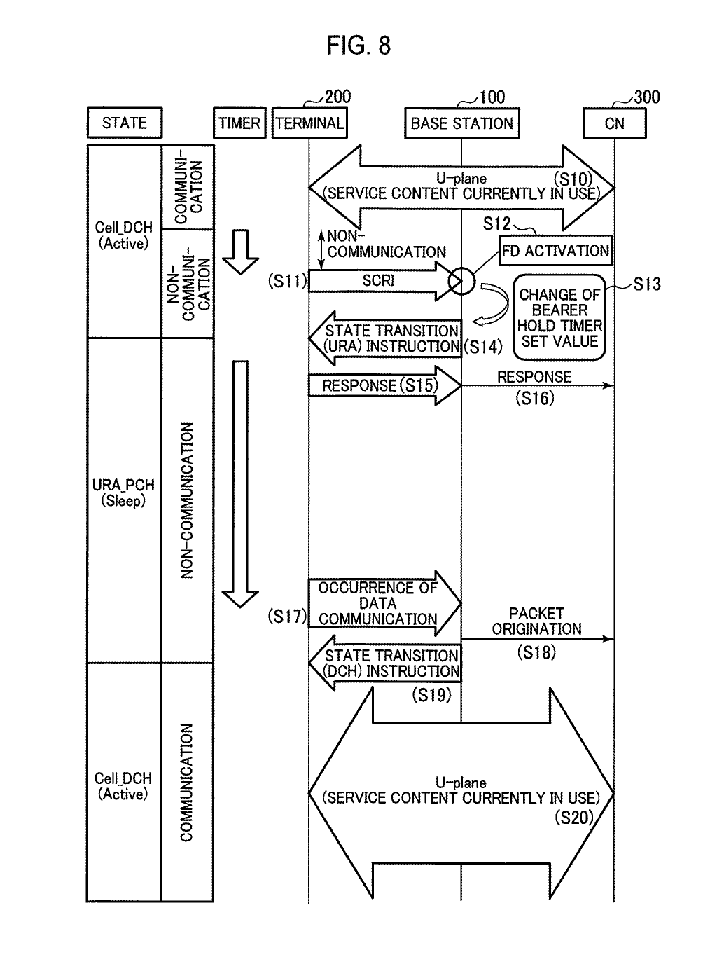

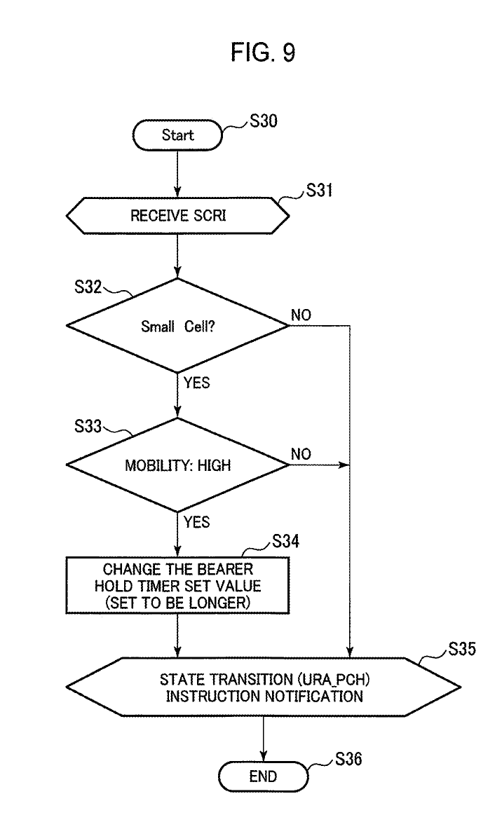

FIG. 8 is a sequence chart illustrating the overall operation example of the radio access system 10, and FIG. 9 through FIG. 12 are flowcharts illustrating the operation example of the base station 100.

First, an example of the overall operation of the radio access system 10 will be described, and next, an operation example of the base station 100 will be described.

### <5-1. Overall Operation Example of Radio Access System>

As depicted in FIG. 8, the terminal 200 transmits and receives user data etc. between with the base station 100 and the CN 300, so as to use a service content (S10). In this case, the terminal 200 is in the “Cell_DCH” state.

Next, when non-communication state continues for a predetermined time, the terminal 200 transmits an SCRI message (S11).

For example, the control unit 222 of the terminal 200 (for example, FIG. 4) monitors data, each signal, etc. which are input and output from/to the baseband unit 223, to count a time having no input/output of the data and the signal by use of a “timer”. The control unit 222, when counting up the predetermined time by the “timer”, discriminates that the terminal 200 is in a non-communication state, so as to generate the SCRI message.

In this case, the control unit 222 transmits the SCRI message by including therein request information for requesting the execution of the “Fast Dormancy” function.

Here, the “timer” may be provided separately from the control unit 222, or may be actualized by the execution of a program in the control unit 222, as a “timer” function.

Returning back to FIG. 8, the base station 100, on receiving the SCRI message, activates the “Fast Dormancy” function according to the “Fast Dormancy” request included in the SCRI message (S12).

For example, the control unit 122 of the base station 100 (for example, FIG. 3) determines to activate the “Fast Dormancy” function when the request information for requesting the execution of the “Fast Dormancy” function is successfully extracted from the SCRI message.

Returning back to FIG. 8, next, the base station 100 changes a bearer hold timer set value according to the attribute of the cell (S13). The bearer hold timer set value signifies a time to maintain the “URA_PCH”, for example. As described earlier, the bearer hold timer set value is fixed in advance as a reference value, for example. However, in the present second embodiment, the reference value can be changed according to the cell attribute. The detail thereof will be described later.

Returning back to FIG. 8, next, by the activation of the “Fast Dormancy” function, the base station 100 instructs the terminal 200 to shift the state of the terminal 200 to the “URA_PCH” (S14).

For example, the control unit 122 of the base station 100 (for example, FIG. 3) generates an instruction message to instruct to shift the state of the terminal 200 to the “URA_PCH”, so as to transmit to the terminal 200. In this case, the control unit 122 generates the instruction message which includes the changed bearer hold timer set value. Here, the control unit 122, when not changing the bearer hold timer set value, may include the fixed reference value of the bearer hold timer set value in the instruction message.

Returning back to FIG. 8, the terminal 200, on receiving the instruction message instructing to shift to the “URA_PCH” (S14), shifts the state of the terminal 200 from the “Cell_DCH” to the “URA_PCH”, and transmits a response message to the base station 100 (S15).

For example, the control unit 222 of the terminal 200 (for example, FIG. 4), on receiving the instruction message from the baseband unit 223, shifts the state of the terminal 200 to the “URA_PCH”.

In the above “URA_PCH” state, as described earlier, there comes to a state in which, although connection to the radio network is maintained, there is no data transmission and reception. For example, in the base station 100 and the CN 300 on the radio network side, a bearer ID indicative of connection with the terminal 200 is held if the terminal 200 becomes the “URA_PCH” state, and also, the control unit 222 of the terminal 200 holds the bearer ID or information related to the bearer ID.

Further, in the “URA_PCH” state, the control unit 222 does not perform data transmission and reception, and maintains the “URA_PCH” state until the occurrence of data, processing by the Keep Alive, or the lapse of a time set by the bearer hold timer set value.

Here, the control unit 222 extracts the bearer hold timer set value from the instruction message received from the baseband unit 223, so that can obtain a set time to maintain the “URA_PCH” state. Further, when shifting the state of the terminal 200 to the “URA_PCH”, the control unit 222 activates the “bearer hold timer” to start counting.

In this case, the set time is set into the “bearer hold timer”, and counting is continued until the set time elapses. When the count value reaches the set time, the “bearer hold timer” expires. On the expiration of the “bearer hold timer”, the control unit 222 shifts the state of the terminal 200 from the “URA_PCH” state to the “IDLE” state.

Here, the count operation may be performed using a “bearer hold timer” which is provided separately from the control unit 222, for example, or alternatively, by the execution of a program in the control unit 222, the “bearer hold timer” may be actualized as a function of the control unit 222.

Returning back to FIG. 8, the base station 100, on receiving a response message from the terminal 200 (S15), generates a response message to transmit to the CN 300 (S16).

For example, on receiving the response message from the baseband unit 123, the control unit 122 of the base station 100 generates a response message indicating that the terminal 200 is shifted to the “URA_PCH”, so as to transmit to the CN 300 through the interface unit 121.

Returning back to FIG. 8, if transmission data occurs before the lapse of the set time set in the “bearer hold timer”, the terminal 200 transmits to the base station 100 a control signal which indicates the occurrence of data communication (S17).

For example, on detection of the occurrence of the transmission data which includes a character, voice, etc. from a display unit, a microphone, etc., the control unit 222 of the terminal 200 (for example, FIG. 4) generates a control signal indicative of the occurrence of data communication, so as to transmit to the base station 100. In this case, the control unit 222 transmits the control signal by shifting the state of the terminal 200 from the “URA_PCH” to the “Cell_FACH”.

Returning back to FIG. 8, on receiving from the terminal 200 the control signal indicative of the occurrence of data communication, the base station 100 generates a message indicating that transmission data occurs in the terminal 200, and transmits the message to the CN 300 (S18).

For example, on receiving from the baseband unit 123 the control signal indicative of the occurrence of data communication, the control unit 122 of the base station 100 (for example, FIG. 3) generates a message indicating that transmission data occurs in the terminal 200, to transmit to the CN 300 through the interface unit 121.

Returning back to FIG. 8, next, the base station 100 instructs the terminal 200 to shift the state of the terminal 200 to the “Cell_DCH” (S19).

For example, the control unit 122 of the base station 100 (for example, FIG. 3) generates an instruction message to instruct to shift the state of the terminal 200 to the “Cell_DCH”, so as to transmit to the terminal 200.

Returning back to FIG. 8, the terminal 200, on receiving the instruction message (S19), shifts the state of the self-terminal 200 from the “Cell_FACH” to the “Cell_DCH”, and transmits the data to the base station 100 and the CN 300 through the base station 100.

For example, on receiving from the baseband unit 223 the instruction message to shift to the “Cell_DCH”, the control unit 222 of the terminal 200 (for example, FIG. 4) shifts the state of the terminal 200 to the “Cell_DCH”, so as to resume data communication.

### <5-2. Operation Example of Base Station>

Next, an operation example of the base station 100 will be described using FIG. 9 through FIG. 12. The operation example of the base station 100 is partially duplicated with the aforementioned overall operation example of the radio access system 10, so that the description will be made with appropriate omission.

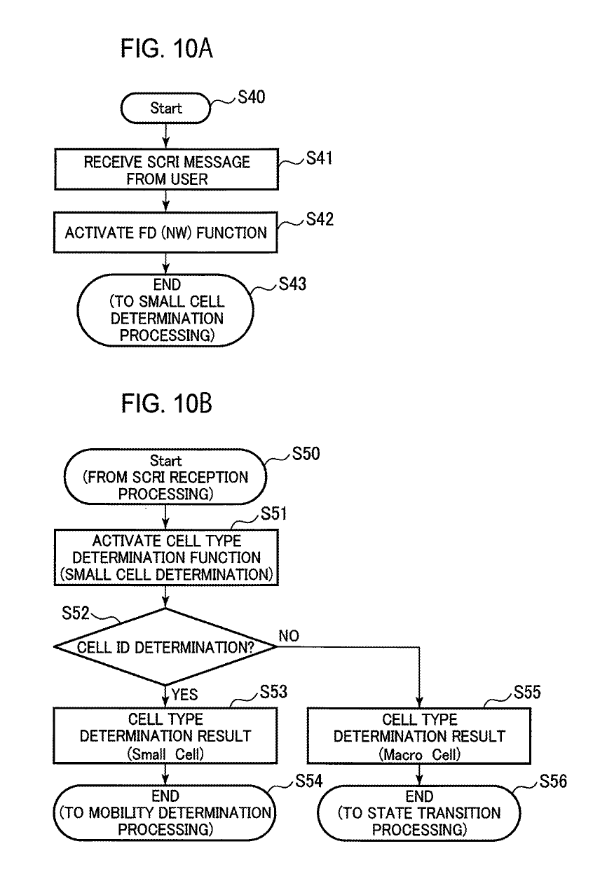

FIG. 9 is a flowchart indicative of the overall operation example of the base station 100. FIGS. 10A through 12 are flowcharts indicative of each operation example.

The overall operation example of the base station 100 will be described using FIG. 9. The base station 100, on starting processing (S30), receives from the terminal 200 an SCRI message which includes information for requesting the execution of the “Fast Dormancy” function (S31).

FIG. 10A is a flowchart illustrating the operation example of the SCRI reception processing (S31). The base station 100, on starting the SCRI reception processing (S40), receives the SCRI message from a user (or the terminal 200) (S41), to activate the “FD (NW)” function (S42). The base station 100 then completes a series of SCRI reception processing (S43).

Returning back to FIG. 9, next, at the time point of receiving the SCRI message from the terminal 200, the base station 100 determines whether to change the bearer hold timer set value according to the cell attribute (S32-S33).

More specifically, if the cell type of an area in which the terminal 200 is communicating is “small cell” (YES in S32), and if the area attribute of the cell is “high mobility” (YES in S33), the base station apparatus 100 changes the bearer hold timer set value (S34).

As described earlier, in the case of the “FD (NW)”, the bearer hold timer set value is, for example, a uniform reference value.

However, in the radio access system 10 like the HetNet, different types of cells are included. Also, there is a case that the terminal 200 moves from one cell to another which are of mutually different types. In such a case, if the bearer hold timer set value is fixed to the uniform reference value, it can hardly be said that a bearer hold timer set value fit to the terminal 200 which moves in the HetNet is set.

Accordingly, the base station 100 changes the bearer hold timer set value to a longer value than the reference value when the cell type of the area in which the terminal 200 is communicating is “small cell”, and when the area attribute of the area concerned (or the area attribute of the cell concerned) is “high mobility”.

For example, the base station 100 changes the bearer hold timer set value to a longer time than the execution time interval of the Keep Alive.

This enables the base station 100 to set a bearer hold timer set value according to the terminal 200 which moves in the HetNet, for example. In particular, by the change of the bearer hold timer set value to a longer time than the predetermined time interval of the execution of the Keep Alive, signal traffic caused by the Cell_update can be reduced further, as compared to the case when the bearer hold timer set value is set to the reference value. The reason will be described later.

Here, the cell attribute indicates, for example, whether or not the cell type of the area in which the terminal 200 is communicating is “small cell”, and also whether or not the area attribute of the area (of the cell) concerned is “high mobility”.

Returning back to FIG. 9, the detail of the processing of S32 and after will be described. The base station 100, on receiving the SCRI message (S31), discriminates whether or not the cell type of the area in which the terminal 200 is communicating is “small cell” (S32).

FIG. 10B is a flowchart illustrating an operation example of small cell determination processing (S32). The base station 100, on starting the processing (S50), activates a cell type determination function (S51). For example, the control unit 122 of the base station 100 (for example, FIG. 3) executes a program for cell type determination, so that can activate the function concerned.

Next, the base station 100 determines a cell ID (S52). For example, the base station 100 determines from the cell ID the cell type of the area in which the terminal 200 is communicating. In this case, for example, the base station 100 may determine the cell type on the basis of the cell ID of a travel destination received from the terminal 200, through the Cell_update processing which is performed in the terminal 200 during data communication (for example, S10 in FIG. 8).

Such determination of the cell ID is executed in, for example, the control unit 122 of the base station 100 (for example, FIG. 3). There are a variety of determination methods using the cell ID. For example, the control unit 122 determines to be a “macro cell” if the cell ID received from the terminal 200 by the Cell_update is smaller than a predetermined number (for example, “50,000”), whereas a “small cell” if the cell ID is the predetermined number of greater. Alternatively, by the storage of each cell type item in a cell ID list held in a memory etc., the control unit 122 may determine by reading out the cell type corresponding to the received cell ID from the cell type item in the cell ID list.

Returning back to FIG. 10B, on deciding that the cell type of the area in which the terminal 200 is communicating is “small cell” (YES in S52), the base station 100 terminates the small cell determination processing, and shifts to mobility determination processing (S53, S54). On the other hand, when the cell type is “macro cell” (NO in S52), the base station 100 terminates the small cell determination processing, and shifts to state transition instruction notification processing (S55, S56).

Returning back to FIG. 9, on deciding that the cell type is “small cell”, the base station 100 performs the mobility determination processing (S33). For example, the base station 100 determines whether the area attribute of the area in which the terminal 200 is communicating indicates “high mobility” or “low mobility”.

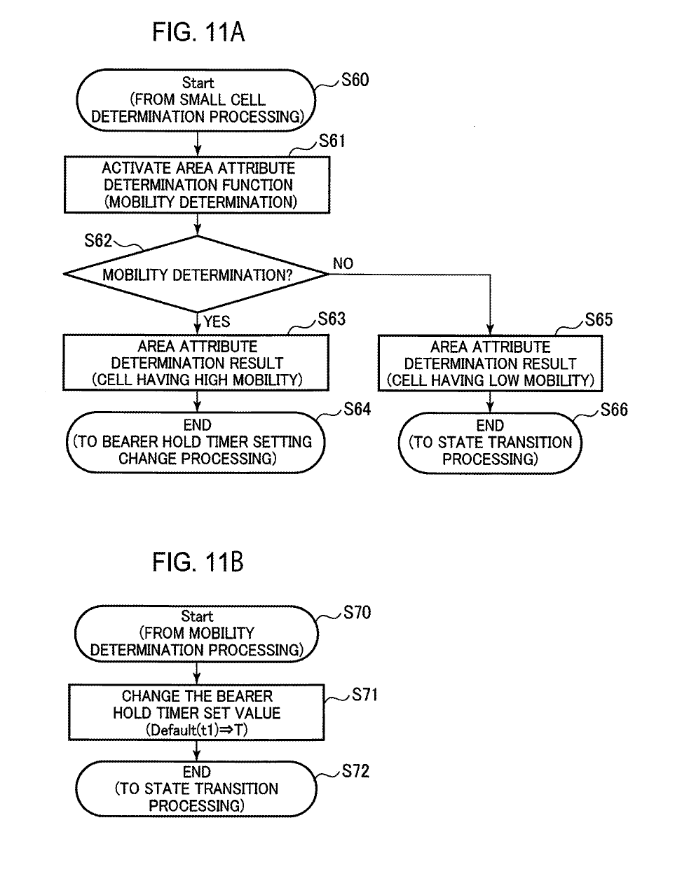

FIG. 11A is a flowchart illustrating an operation example of the mobility determination processing (S33). On starting the mobility determination processing (S60), the base station 100 activates an area attribute determination function (S61). For example, the control unit 122 of the base station 100 (for example, FIG. 3) executes a program for area attribute determination, so that can activate the area attribute determination function.

Returning back to FIG. 11A, next, the base station 100 performs mobility determination (S62). For example, the mobility determination is performed in the control unit 122 of the base station 100 (for example, FIG. 3). As a determination method, for example, an “area having a railroad and a highway” in the cell concerned can be determined to be a “high mobility” area, whereas another area can be determined to be a “low mobility” area.

More specifically, the determination is made in the following manner, for example. Namely, the control unit 122 receives a cell ID notified from the terminal 200 by the Cell_update to thereby discriminate a cell in which the terminal 200 is communicating and obtain the position information of the cell of concern. The cell position information includes a predetermined area in a radius of 500 meters etc., for example. The control unit 122 then compares the cell position information with map information, to identify the area in the map information corresponding to the cell position information, so that can determine based on whether there is vector information related to “railroad” and “highway” in the identified area. The control unit 122, for example, downloads the map information through the Internet 400, to perform mobility determination using the most up-to-date map information.

When the base station 100 determines that the area attribute of the area in which the terminal 200 is communicating indicates “high mobility” (YES in S62), the base station 100 terminates the mobility determination processing, to shift to bearer hold timer setting change processing (S63, S64). On the other hand, on deciding that the area attribute of the area in which the terminal 200 is communicating indicates “low mobility” (NO in S62), the base station 100 terminates the mobility determination processing, to shift to the state transition instruction notification processing (S65, S66).

Returning back to FIG. 9, on the determination of “high mobility” (YES in S33), the base station 100 performs the bearer hold timer setting change processing (S34).

FIG. 11B is a flowchart illustrating an operation example of the bearer hold timer setting change processing (S34). On starting the bearer hold timer setting change processing (S70), the base station 100 changes the setting of the bearer hold timer (S71).

The setting change of the bearer hold timer is performed in, for example, the control unit 122 of the base station 100 (for example, FIG. 3). The control unit 122 sets a bearer hold timer set value to be a longer value than the reference value. Here the value to be set may be either a fixed value or a variable value. In the case of the fixed value, the control unit 122 reads out the value held in the memory etc., so that can determine the value to be the bearer hold timer set value.

As an example of variable value setting, for example, there is an example as follows.

### (Variable Value Setting Example 1)

Let t1 [sec] be the reference value of the bearer hold timer set value, and a “n” be a variable, then a variable value T is expressed as

T=n·t1 [sec] (1)

The variable “n” of the variable value T is determined in the following manner, for example. Namely, when a Keep Alive period while the terminal 200 uses an application is t2 [sec], determine a variable “n” which satisfies

T>t2.

In this case, the variable “n” is

n·t1>t2,

therefore

n>(t2/t1) (2)

is obtained.

For example, the control unit 122 holds the reference value “t1” and the Keep Alive period “t2” in the memory etc., and substitutes the above values into expression (2), so as to obtain a variable “n” which satisfies expression (2). The control unit 122 then substitutes the obtained variable “n” into expression (1) to obtain a variable value T.

### (Variable Value Setting Example 2)

Supposing there are known values of a moving speed v [km/h] of the terminal 200 and a distance x [m] from the present position of the terminal 200 to a cell edge, let t [sec] be a time consumed when the terminal 200 moves from the present position to a cell edge, then

t=3.6x/v≧T>t2

therefore,

t=3.6x/v>t2 (3)

is obtained.

Here, if expression (3) is not satisfied, in other words, 3.6x/v<t2 is held, the terminal 200 passes through a “small cell” area while moving in the cell. In this case, for example, the control unit 122 does not change the setting of the bearer hold timer.

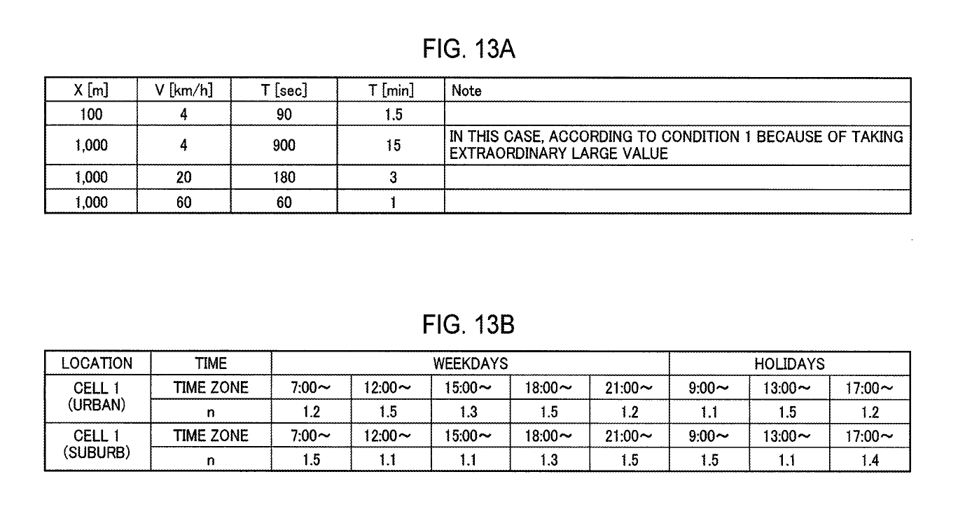

FIG. 13A illustrates an example of the values of the movement time t (=T) which can be taken in combination between the values of a distance x (=X) to the cell edge and a moving speed v (=V). It is assumed that the movement time t (=T) depicted in FIG. 13A satisfies expression (3).

For example, the control unit 122, when acquiring the moving speed v and the distance x, confirms whether or not expression (3) is satisfied. Then, the control unit 122 may be configured to determine the variable set value when expression (3) is satisfied, using another setting example (for example, variable value setting example (1)), for example.

### (Variable Value Setting Example 3)

It is also possible to perform statistic processing for each set variable value T in an OAM (Operation, Administration and Maintenance: monitor and control) apparatus (or system) etc., and based on the result thereof, obtain the average value of the variable value T, so as to set the variable “n” of the variable value T.

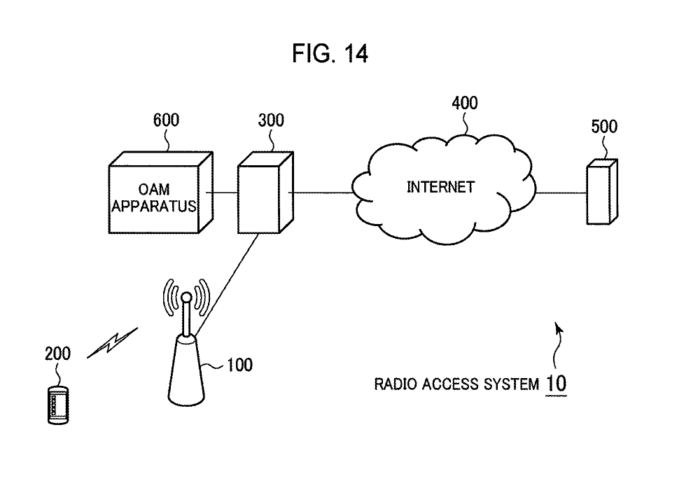

FIG. 14 is a diagram illustrating a configuration example of the radio access system 10 which includes an OAM apparatus 600. The OAM apparatus 600 receives from the base station 100 and the CN 300 the feedback result of operation information, and receives the variable value T and the variable n included in the operation information. In this case, time, location or district, in which the variable value T and the variable n are set, is included in the operation information. The OAM apparatus 600 holds in a memory etc. the variable value T and the variable n according to the time and the place, as statistic information.

FIG. 13B is a diagram illustrating an example of the statistic information held in the OAM apparatus 600. In the example of FIG. 13B, there are included “time zone”, “weekdays” and “holidays” as time, and “cell 1 (urban)” and “cell 2 (suburb)” as location. In this case, the control unit 122 of the base station 100 obtains the time and the location when the variable n is set from map information, a timer, etc., to transmit to the OAM apparatus 600 as operation information. The OAM apparatus 600 obtains such operation information to hold the statistic information as depicted in FIG. 13B.

Then, when setting the variable value T, the control unit 122 of the base station 100 obtains a set time and a location from the timer and the map information, to transmit to the OAM apparatus 600, so that the OAM apparatus 600 reads out the variable “n” corresponding to the received time and the location. The OAM apparatus 600 then transmits the variable “n” to the base station 100, and the control unit 122 of the base station 100 sets the variable value T on the basis of the received variable “n”, using expression (1) etc.

Here, in an early stage of the setting of the variable value T, the above-mentioned (Variable value setting example 1) or (Variable value setting example 2) may be applicable, because of a lack of the number of statistic information items.

Also, although the description is given in the example of FIG. 13B on the example in which the variable “n” is included in the statistic information, the variable value T itself may be included in the statistic information. Also, although the description is given in the example of FIG. 13B on the example in which the time and the location are included as the statistic information, it is possible that either one of the time and the location is used according to the environment condition of the radio access system 10 and the values of a variety of set parameters, or information other than the time and the location is included.

### (Variable Value Setting Example 4)

It is also possible that a system operator arbitrarily sets the variable value T. In this case, for example, the variable value T may be arbitrarily set by the system operator using the variable “n” of expression 1, or the variable value T itself may be set. As to a condition set to FIG. 13B, another item than the time zone and the location is settable by the operator. Based on the set condition, the control unit 122 changes the setting of the bearer hold timer.

That is all for the description on the variable value setting examples.

Returning back to FIG. 11B, the base station 100, on completion of changing the setting of the bearer hold timer (S71), completes the bearer hold timer setting change processing (S72).

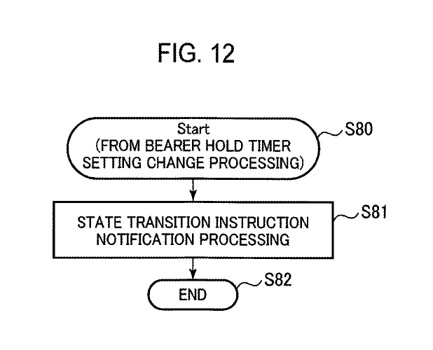

Returning back to FIG. 9, after changing the setting of the bearer hold timer, the base station 100 performs the state transition instruction notification processing (S35). FIG. 12 is a flowchart illustrating an operation example of the state transition instruction notification processing.

The base station 100, on starting the state transition instruction notification processing (S80), performs state transition instruction notification (S81). For example, the control unit 122 of the base station 100 generates an instruction message to instruct the terminal 200 to shift to the “URA_PCH”, and transmits the generated instruction message to the terminal 200. At this time, the control unit 122 transmits the instruction message by including therein the changed bearer hold timer set value.

Here, the control unit 122 transmits the instruction message to instruct to shift to the “URA_PCH” after deciding to be “macro cell” in the determination of a cell type (NO in S32 of FIG. 9) and after deciding to be “low mobility area” in the determination of mobility (NO in S33 of FIG. 9) also. In this case, because the control unit 122 maintains the reference value intact as the bearer hold timer set value, the control unit 122 transmits the instruction message by including therein the reference value, as the bearer hold timer set value.

Returning back to FIG. 12, the base station 100, on completion of the state transition instruction notification (S81), completes the state transition instruction notification processing (S82).

Returning back to FIG. 9, on completion of the state transition instruction notification processing (S35), the base station 100 completes a series of processing (S36).

### <5-3. Example of Information Update in Each State>

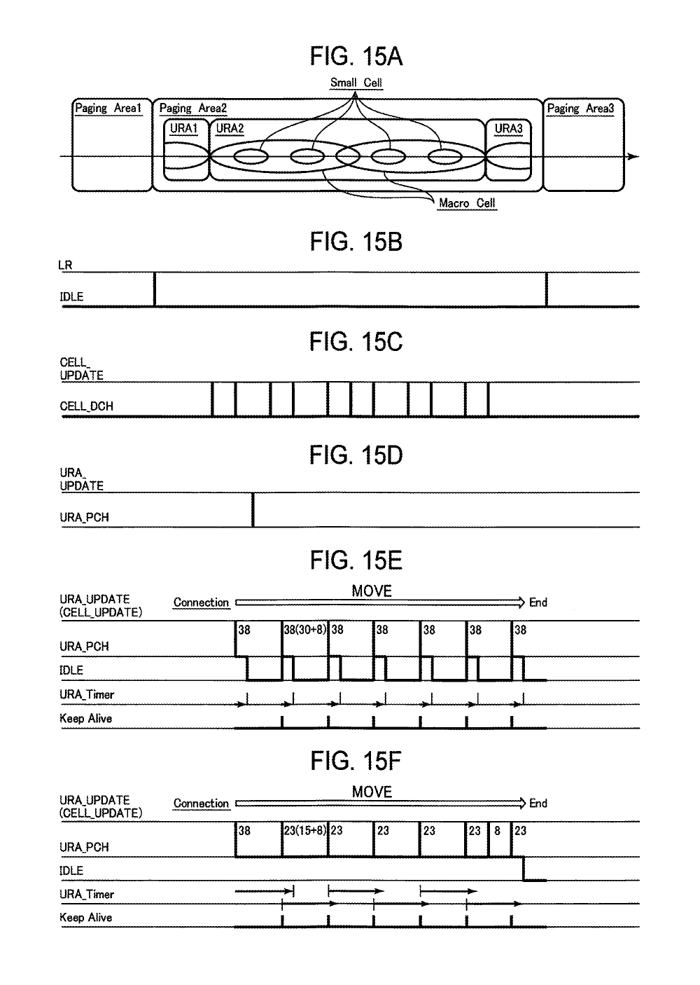

Next, an example of information update in the terminal 200 will be described. FIG. 15A illustrates an example of a HetNet environment, and FIGS. 15B through 15F illustrate the way of updating information by the terminal 200 in each state.

FIG. 15A is a diagram illustrating an example of the HetNet environment in the radio access system 10. In the example of FIG. 15A, there are three paging areas i.e. a paging area1 to a paging area3. The terminal 200 moves from the paging area1 to the paging area3 as depicted with an arrow.

The paging area2 includes the URA1 to the URA3, and the terminal 200 moves from the URA1 to the URA3. There are two macro cells included in the URA2, and further, there are two small cells included in each macro cell.

As depicted in FIG. 15A, the terminal 200 traverses two macro cells and four small cells in the URA2. The examples of information update when the terminal 200 moves as such are depicted in FIGS. 15B through 15D. In FIGS. 15B through 15D, the horizontal axes represent the time and the vertical axes represent states and examples of transmission information.

FIG. 15B illustrates an example of information update when the terminal 200 moves in the “IDLE” state.

As described earlier, the terminal 200 in the “IDLE” state does not perform the Cell_update even when moving from one cell to another within the same paging area. In this case, if the terminal 200 moves to a different paging area, the terminal 200 performs information update (for example, Location Registration: LR). In the example of FIG. 15B, the terminal 200 performs information update twice, namely, when moving from the paging area1 to the paging area2 and when moving from the paging area2 to the paging area3.

FIG. 15C illustrates an example of the information update when the terminal 200 in an active state moves.

The terminal 200 in the active state performs Cell_update when moving from one cell to another. By the execution of the Cell_update, the terminal 200 can notify the base station 100 of the present location, for example. Then, based on the notification, the base station 100 can grasp the ID of the cell in which the terminal 200 is currently located, and also the cell attribute. In the example of FIG. 15C, the terminal 200 performs 11 times of information update.

FIG. 15D illustrates an example of information update when the terminal 200 in the “URA_PCH” state is stationary.

The terminal 200 in the “URA_PCH” state performs the information update when moving from one URA to another, for example. In the example of FIG. 15D, the terminal 200 performs URA_update when moving to the URA2, to perform the information update. By the URA_update, the base station 100 can grasp a URA in which the terminal 200 is located.

FIG. 15E illustrates an example of information update when the terminal 200 in the “URA_PCH” state moves within the URA. In the example of FIG. 15E, the set value of the bearer hold timer is the reference value.

The terminal 200 performs the URA_update when moving within the URA. In this case, the terminal 200 shifts from the “URA_PCH” to the active state and performs the URA_update.

After performing the URA_update, the terminal 200 shifts from the active state to the “URA_PCH” again. After shifting to the “URA_PCH”, when it becomes a set time (“URA_Timer” in FIG. 15) set by the bearer hold timer set value, the terminal 200 shifts from the “URA_PCH” to the “IDLE”.

After shifting to the “IDLE” state, when it becomes a predetermined time to perform the Keep Alive, the terminal 200 shifts from the “IDLE” state to the active state and performs the Keep Alive.

The terminal 200 after performing the Keep Alive returns to the “URA_PCH” state again. Thereafter, the terminal 200 repeats the above-mentioned processing when moving within the URA.

Then, the terminal 200 performs the URA_update when moving to the outside of the URA.

In the example of FIG. 15E, the terminal 200 performs at least 7 times of information update.

Here, a numeral described in FIG. 15E represents the number of messages (or the number of control signals) which are transmitted and received between the terminal 200 and the base station 100.

For example, the terminal 200, when shifting from the “URA_PCH” to the active state by the URA_update, transmits and receives “38” messages between with the base station 100. Also, the terminal 200 transmits and receives “38” messages when shifting from the “IDLE” to the active state by the Keep Alive. More specifically, the terminal 200 transmits and receives “30” messages when shifting from the “IDLE” to the “Cell_FACH”, and “8” messages when shifting from the “Cell_FACH” to the “Cell_DCH”, which are totally “38” messages.

FIG. 15F illustrates an example of information update when the terminal 200 in the “URA_PCH” state moves within the URA in a case when the bearer hold timer set value is set to a longer time than the reference value. As such, when the attribute of the cell in which the terminal 200 is located is “small cell” and “high mobility”, the bearer hold timer set value is set to a longer time than the reference value, as described earlier.

In the example of FIG. 15F, when moving within the URA, the terminal 200 shifts from the “URA_PCH” to the active state and performs the URA_update, similar to the example of FIG. 15E.

Because the bearer hold timer set value is set longer than the reference value, a time during which the terminal 200 maintains the “URA_PCH” state becomes longer than the case of FIG. 15E. Desirably, the bearer hold timer set value which is set longer than the reference value is longer than a predetermined time interval of the execution of the Keep Alive. By such setting, at the time of the Keep Alive, the terminal 200 can be set to the “URA_PCH”, not the “IDLE”.

In the example of FIG. 15F, on reaching a predetermined time to perform the Keep Alive, the terminal 200 shifts from the “URA_PCH” to the active state and performs the Keep Alive. In this case, when shifting from the “URA_PCH” to the active state, the terminal 200 transmits and receives “23” messages. More specifically, the terminal 200 transmits and receives “15” messages when shifting from the “URA_PCH” to the “Cell_FACH” and “8” messages when shifting from the “Cell_FACH” to the “Cell_DCH”, which are totally “23” messages.

The number of messages in one time of the Keep Alive is “38” in the case of the shift from the “IDLE” to the active state (for example, FIG. 15E), whereas “23” in the case of the shift from the “URA_PCH” to the active state (for example, FIG. 15F). Thus, in the case of the shift from the “URA_PCH” to the active state, “15” messages can be reduced as compared to the case of the shift from the “IDLE” to the active state. Also, the total number of messages is 38×7=266 in the example of FIG. 15E, whereas 38+23×6+8=184 in the example of FIG. 15F, and thus, “82” messages can be reduced.

Accordingly, in the radio access system 10, by setting the bearer hold timer set value longer than the reference value, for example, there is produced a shift from the “URA_PCH” state to the active state, and thus, as compared to the case of the reference value, the number of messages can be reduced. As a result, the elongation of the bearer hold timer set value to be longer than the reference value enables the suppression of signal traffic, for example.

Further, by the suppression of the signal traffic, for example, the number of times of signal transmission and reception in the terminal 200 is reduced, which enables the suppression of power consumption in the terminal 200 and the elongation of the battery available time.

### OTHER EMBODIMENTS

Next, other embodiments will be described.

In the second embodiment, for example as depicted in FIG. 5, the example in which one cell is included in one base station 100 is described. However, a plurality of cells may be included in one base station 100, for example.

Also, in the second embodiment, for example as depicted in FIG. 3, the example in which one radio unit 110 is included in the base station 100 is described. For example, a plurality of radio units 110 may be included in the base station 100.

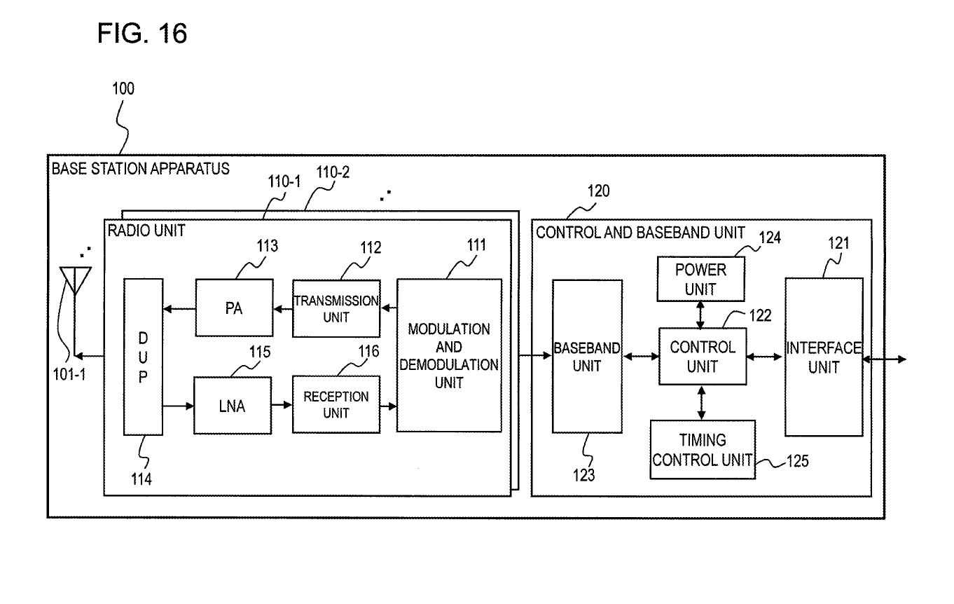

FIG. 16 is a diagram illustrating a configuration example of the base station 100 when a plurality of radio units 110-1, 110-2, . . . are included in the base station 100. The plurality of radio units 110-1, 110-2, . . . are connected to the control and baseband unit 120. Further, radio units 110-1, 110-2, . . . may be installed at mutually different locations.

Further, in the second embodiment, there is described the example in which the bearer hold timer set value is set longer than the reference value, to thereby elongate the time to maintain the “URA_PCH” state longer than the reference value. For example, the present embodiment is applicable if the terminal 200, though not in the “URA_PCH” state, is in a state capable of maintaining connection with the base station 100 and performing processing to confirm the connection at predetermined time intervals to the base station 100 without data transmission and reception.

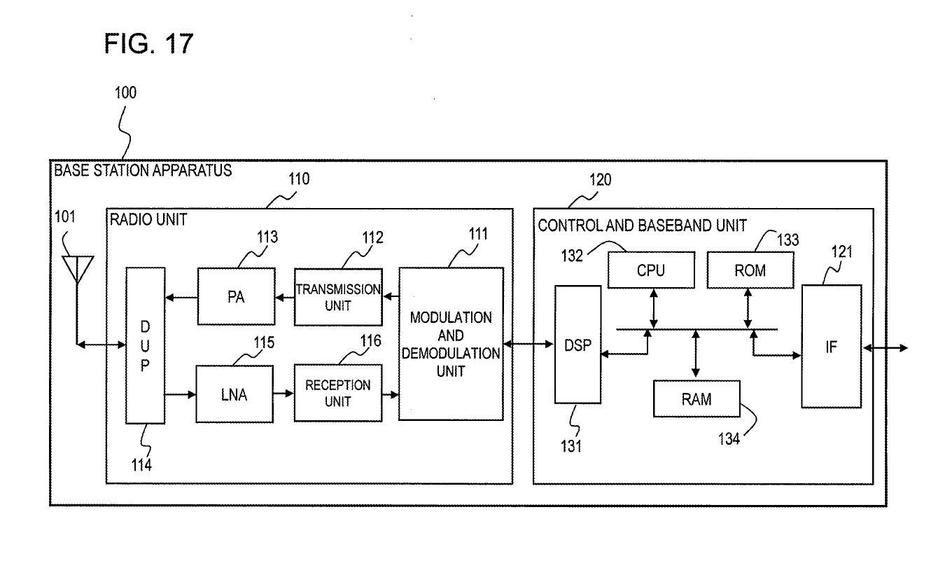

Further, in the second embodiment, as the configuration example of the base station 100, the description is given based on the example of FIG. 3. FIG. 17 is a diagram illustrating a hardware configuration example of the base station 100.

The base station 100 further includes a DSP (Digital Signal Processor) 131, a CPU (Central Processing Unit) 132, a ROM (Read Only Memory) 133 and a RAM (Random Access Memory) 134.

The DSP 131 performs processing of error correction coding, modulation, error correction decoding, demodulation, etc. on data and a signal which are output from the modulation and demodulation unit 111 and data, a signal, etc. which are output from the IF 121, according to each instruction from the CPU 132. The DSP 131 outputs the data and the signal on which the above processing is performed to the IF 121 and the modulation and demodulation unit 111, according to the instruction of the CPU 132.

The CPU 132 reads out a program stored in the ROM 133 to load on the RAM 134, and executes the loaded program, to thereby actualize each function performed in the control unit 122 and the timing control unit 125.

The CPU 132 corresponds to, for example, the control unit 122 and the timing control unit 125 in the second embodiment. Also, the DSP 131 corresponds to, for example, the baseband unit 123 in the second embodiment. Further, the IF 121 corresponds to, for example, the interface unit 121 in the second embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio access system comprising:
a terminal apparatus, and
a base station apparatus, wherein
a first and second communicable areas of different size are located in hierarchy,
the terminal apparatus moving from the first communicable area to the second communicable area and the base station apparatus perform radio communication,
the base station apparatus includes:
a control unit configured to change a time to maintain connection with the base station apparatus in the terminal apparatus and maintain a first state confirming connection to the base station apparatus at predetermined time interval without performing data transmission and reception, to a time longer than a reference time, according to an attribute of the first or second communicable area in which the terminal apparatus locates; and
a transmission unit configured to transmit the changed time to maintain the first state to the terminal apparatus, and
the terminal apparatus includes:
a reception unit configured to receive the changed time to maintain the first state.

2. The radio access system according to claim 1, wherein
the terminal apparatus of the first state is configured to transmit information relating a second area to the base station apparatus, when the terminal apparatus of the first state moves from a first area including a plurality of communicable areas to a second area including a plurality of communicable area difference to the plurality of communicable areas included in the first area.

3. The radio access system according to claim 1, wherein
the attribute of the first or second communicable area is a communicable area where the first or second communicable area in which the terminal apparatus is located is smaller than the largest communicable area respectively, and a communicable area where the terminal apparatus moves with higher possibility than another communicable area respectively.

4. The radio access system according to claim 3, wherein
the control unit is configured to determine whether or not the attribute of the first or second communicable area is the communicable area smaller than the largest communicable area based on identification information of the first or second communicable area obtained by communication with the terminal apparatus, and determine whether or not the first or second communicable is in which the terminal apparatus is located is the communicable area where the terminal apparatus moves with higher possibility than the other communicable area based on the obtained identification information of the first or second communicable area and map information.

5. The radio access system according to claim 1, wherein
the control unit is configured to change the time to maintain the first state to a time longer than the predetermined time confirming connection to the base station apparatus.

6. The radio access system according to claim 1, wherein
the control unit is configured to change the time to maintain the first state to the time longer than the reference time, when movement time until the terminal apparatus moves outside of the first or second communicable area is longer than the predetermined time confirming connection to the base station apparatus in the terminal apparatus.

7. The radio access system according to claim 1, further comprising:
a monitor control apparatus configured to hold the changed time to maintain the first state, wherein
the control unit is configured to change the time to maintain the first state to the time longer than the reference time, based on the changed time to maintain the first state hold in the monitor control apparatus.

8. The radio access system according to claim 7, wherein
the control unit is configured to transmit to the monitor control apparatus formation relating to time zone at changed time and a location in which the terminal apparatus locates, when the control unit is configured to change the time to maintain the first state, and
the control unit is configured to change the time to maintain the first state to the time longer than the reference time, based on the time zone and the location in which the terminal apparatus locates.

9. The radio access system according to claim 7, wherein
the control unit is configured to transmit information relating set condition to the monitor control apparatus when the control unit is configured to change the time to maintain the first state, and
the control unit is configured to change the time to maintain the first state to the time longer than the reference time, based on the set condition.

10. The radio access system according to claim 1, wherein
the first state is a URA_PCA (UTRAN Registration Area Paging Channel) state.

11. A base station apparatus for performing radio communication with a terminal apparatus moving from a first communicable area to a second communicable area, the first and second communicable areas of different size located in hierarchy, the base station apparatus comprising:
a control unit configured to change a time to maintain connection with the base station apparatus in the terminal apparatus and maintain a first state confirming connection to the base station apparatus at predetermined time interval without performing data transmission and reception, to a time longer than a reference time, according to an attribute of the first or second communicable area in which the terminal apparatus locates; and
a transmission unit configured to transmit the changed time to maintain the first state to the terminal apparatus.
